(19) United States
(12) Patent Application Publication
(10) Pub. No.: US 2024/0322280 A1
(43) Pub. Date: Sep. 26, 2024

(54) Battery Cutting Device

(71) Applicant: SK On Co., Ltd., Seoul (KR)

(72) Inventors: Jae Sik SHIN, Daejeon (KR); Bo Kyung KO, Daejeon (KR); Do Il PARK, Daejeon (KR); Seung Hoon JU, Daejeon (KR)

(21) Appl. No.: 18/418,490

(22) Filed: Jan. 22, 2024

(30) Foreign Application Priority Data
Mar. 22, 2023 (KR) 10-2023-0037264

(51) Int. Cl. H01M 10/54; C22B 1/00

(52) U.S. Cl. CPC H01M 10/54; C22B 1/005

(57) ABSTRACT

Battery cutting devices are disclosed. In an implementation, a battery cutting device can cut a case of a secondary battery in a longitudinal direction, a thickness direction, and a width direction. The battery cutting device includes a jig unit fixing the secondary battery and a cutter unit cutting the secondary battery.

### CROSS-REFERENCE TO RELATED APPLICATIONS

This patent document claims the priority and benefits of Korean Patent Application No. 10-2023-0037264 filed on Mar. 22, 2023, the entire contents of which are incorporated herein by reference as part of the disclosure of this application.

### TECHNICAL FIELD

The disclosed technology relates to a battery cutting device. More particularly, the disclosed technology relates to a battery cutting device cutting a rectangular secondary battery.

### BACKGROUND

When a secondary battery reaches the end of its life or is damaged, the secondary battery must be discarded. However, an electrode assembly of the secondary battery can be recycled. Therefore, in a process of discarding the secondary battery, it is necessary to cut the secondary battery without damaging the electrode assembly of the secondary battery.

### SUMMARY

The disclosed technology can be implemented in some embodiments to provide a battery cutting device that can cut a case of a battery in a plurality of different directions.

The disclosed technology can also be implemented in some embodiments to provide a battery cutting device that can cut a case of a battery along a plurality of intersecting cut lines.

In one aspect of the disclosed technology, a battery cutting device may comprise a jig unit including a longitudinal jig unit, a thickness jig unit, and a width jig unit, and a cutter unit coupled to the jig unit, wherein the longitudinal jig unit includes a first longitudinal jig module and a second longitudinal jig module that are arranged in a longitudinal direction and approach or move away from each other, wherein the thickness jig unit includes a first thickness jig module and a second thickness jig module that are arranged in a thickness direction and approach or move away from each other, wherein the width jig unit includes a first width jig module and a second width jig module that are arranged in a width direction and approach or move away from each other, wherein the cutter unit includes a moving module fixed to the jig unit, and a cutting module coupled to the moving module to be movable in one direction and including a cutting blade.

The cutter unit may further include a thickness cutter unit coupled to the width jig unit, and the cutting module of the thickness cutter unit may be coupled to the moving module of the thickness cutter unit to be movable in the thickness direction.

The thickness cutter unit may be coupled to an inner surface of the first width jig module, and the inner surface of the first width jig module may face the second width jig module.

The cutter unit may further include a longitudinal cutter unit coupled to the width jig unit, and the cutting module of the longitudinal cutter unit may be coupled to the moving module of the longitudinal cutter unit to be movable in the longitudinal direction.

The longitudinal cutter unit may be coupled to the inner surface of the first width jig module, and the second width jig module may approach or move away from the first width jig module.

The first width jig module may be positioned above the second width jig module.

The cutter unit may further include a width cutter unit coupled to the thickness jig unit, and the cutting module of the width cutter unit may be coupled to the moving module of the width cutter unit to be movable in the width direction.

The width cutter unit may be coupled to an inner surface of the first thickness jig module, and the inner surface of the first thickness jig module may face the second thickness jig module.

The second thickness jig module may approach or move away from the first thickness jig module.

A movement path of the cutting module of the width cutter unit may meet a movement path of the cutting module of the thickness cutter unit.

A movement path of the cutting module of the thickness cutter unit may meet a movement path of the cutting module of the longitudinal cutter unit.

The first thickness jig module may be positioned behind the second thickness jig module, and the first width jig module may be positioned above the second width jig module.

The first longitudinal jig module may form an opening.

The moving module may include a frame fixed to the jig unit, a guide rail installed on the frame and forming a shape extending in the one direction, a guide block installed on the frame and coupled to the guide rail to be movable in the one direction, and a guide table coupled to the guide block and coupled to the cutting module.

The moving module may further include a moving rod installed on the frame and forming a shape extending in the one direction, and a rod coupler coupled to at least one of the guide block or the guide table and movably coupled to the moving rod. When the moving rod rotates, the cutting module may move in the one direction.

In an embodiment of the disclosed technology, there can be provided a battery cutting device cutting a case of a battery in a plurality of different directions.

In an embodiment of the disclosed technology, there can also be provided a battery cutting device cutting a case of a battery along a plurality of intersecting cut lines.

The battery cutting device based on an embodiment of the disclosed technology can be widely applied to green technology fields, such as electric vehicles, battery charging stations, solar power generation using other batteries, or wind power generation.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a secondary battery.

FIG. 2 illustrates a battery cutting device based on an embodiment of the disclosed technology.

FIG. 3 illustrates that a first thickness jig module is removed from a battery cutting device illustrated in FIG. 2.

FIG. 4 illustrates a cutter unit based on an embodiment of the disclosed technology.

FIG. 5 illustrates a moving module based on an embodiment of the disclosed technology.

FIG. 6 illustrates that a part of a moving module illustrated in FIG. 5 is cut.

FIG. 7 illustrates a cutting module based on an embodiment of the disclosed technology.

FIG. 8 schematically illustrates that a battery cutting device based on an embodiment of the disclosed technology cuts a secondary battery.

### DETAILED DESCRIPTION

Reference will now be made in detail to embodiments of the disclosed technology, examples of which are illustrated in the accompanying drawings. However, the following description is merely an example and does not limit the disclosed technology to a specific implementation.

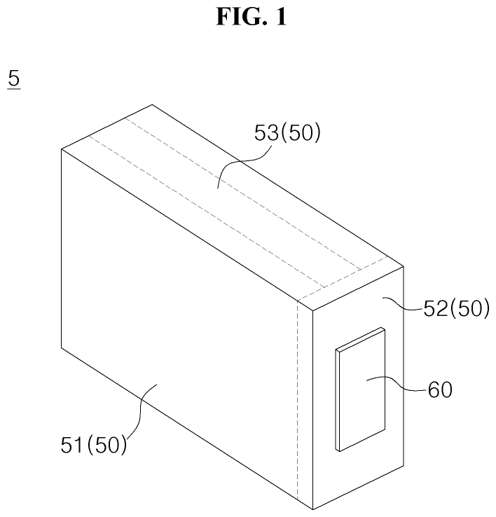

FIG. 1 illustrates a secondary battery.

Referring to FIG. 1, a secondary battery 5 may form an overall hexahedral shape. The secondary battery 5 may store electrical energy through charging. The secondary battery 5 may provide electrical energy through discharge.

The secondary battery 5 may include a secondary battery case 50. The secondary battery case 50 may accommodate an electrode assembly. The secondary battery case 50 may form an outer surface of the secondary battery 5.

The secondary battery case 50 may include a first side case 51. The first side case 51 may form a widest surface among a plurality of surfaces of the secondary battery 5. The first side case 51 may form a shape extending in one direction. A longitudinal direction of the first side case 51 may be a longitudinal direction of the secondary battery 5.

The secondary battery case 50 may include a second side case 52. The second side case 52 may be connected to a longitudinal end of the first side case 51. A terminal unit 60 may be disposed on the second side case 52.

The secondary battery 5 may include the terminal unit 60. The terminal unit 60 may form a shape protruding from the second side case 52. The terminal unit 60 may be connected to the electrode assembly of the secondary battery 5.

The secondary battery case 50 may include a third side case 53. The third side case 53 may be bent at an edge extending in the longitudinal direction among edges of the first side case 51 to form an extended shape.

When the secondary battery 5 reaches the end of its life or is damaged, it may be discarded. The electrode assembly of the secondary battery 5 to be discarded may contain useful materials. For example, a cathode material and an anode material of the secondary battery 5 may contain useful materials. That is, when the secondary battery 5 is discarded, it is necessary to recover the material included in the electrode assembly of the secondary battery 5.

In order to recover the material included in the electrode assembly of the secondary battery 5, the secondary battery case 50 needs to be cut. For example, the secondary battery case 50 may be cut along the dotted line illustrated in FIG. 1.

For example, the third side case 53 may be cut along two cut lines that are arranged in the longitudinal direction and are parallel to each other, and may be cut along a cut line that is adjacent to the second side case 52 and is arranged in a width direction. For example, the first side case 51 may be cut along the cut line that is adjacent to the second side case 52 and is arranged in the width direction.

A device may be needed to effectively cut the secondary battery case 50. The device for cutting the secondary battery case 50 may fix the secondary battery 5 and cut the fixed secondary battery 5.

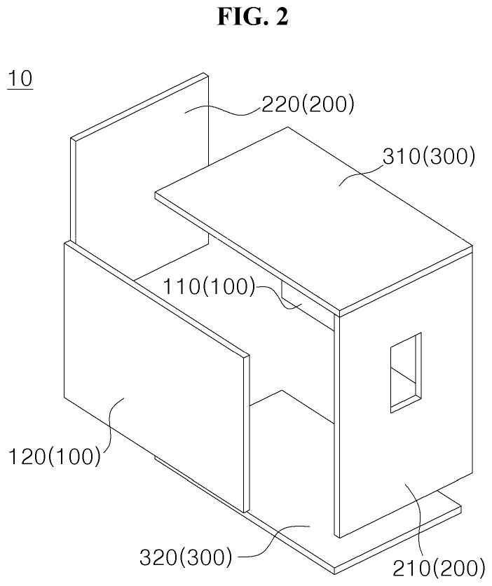

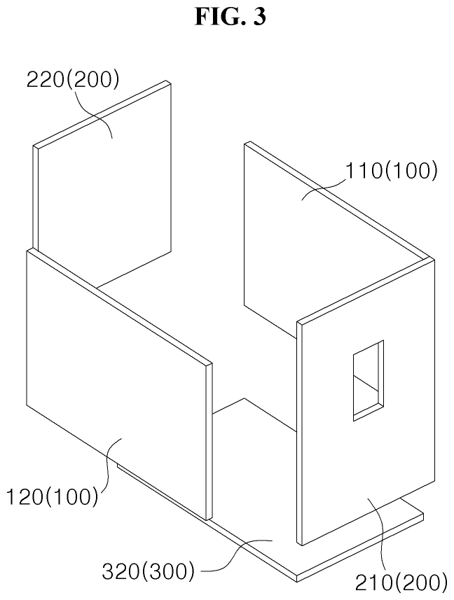

FIG. 2 illustrates a battery cutting device 10 based on an embodiment of the disclosed technology. FIG. 3 illustrates that a first thickness jig module 110 is removed from the battery cutting device 10 illustrated in FIG. 2.

Referring to FIGS. 2 and 3, the battery cutting device 10 may accommodate, fix, and cut the secondary battery 5 (see FIG. 1).

The battery cutting device 10 may include a thickness jig unit 100. The thickness jig unit 100 may include a first thickness jig module 110 and a second thickness jig module 120.

The first thickness jig module 110 and the second thickness jig module 120 may be arranged in a thickness direction of the battery cutting device 10. The thickness direction of the battery cutting device 10 may be a thickness direction of the secondary battery 5 (see FIG. 1).

The first thickness jig module 110 and the second thickness jig module 120 may face each other. The first thickness jig module 110 and the second thickness jig module 120 may be spaced apart from each other. Each of the first thickness jig module 110 and the second thickness jig module 120 may include a plate.

The first thickness jig module 110 and the second thickness jig module 120 may approach or move away from each other. For example, one of the first thickness jig module 110 and the second thickness jig module 120 may be fixed, and the other may move. For example, the first thickness jig module 110 may be fixed, and the second thickness jig module 120 may move closer to or away from the first thickness jig module 110.

The battery cutting device 10 may include a longitudinal jig unit 200. The longitudinal jig unit 200 may include a first longitudinal jig module 210 and a second longitudinal jig module 220.

The first longitudinal jig module 210 and the second longitudinal jig module 220 may be arranged in the longitudinal direction of the battery cutting device 10. The longitudinal direction of the battery cutting device 10 may be the longitudinal direction (or length direction) of the secondary battery 5 (see FIG. 1).

The first longitudinal jig module 210 and the second longitudinal jig module 220 may face each other. The first longitudinal jig module 210 and the second longitudinal jig module 220 may be spaced apart from each other. Each of the longitudinal type jig module 210 and the second longitudinal jig module 220 may include a plate.

The first longitudinal jig module 210 and the second longitudinal jig module 220 may approach or move away from each other. For example, one of the first longitudinal jig module 210 and the second longitudinal jig module 220 may be fixed, and the other may move. For example, the first longitudinal jig module 210 may be fixed, and the second longitudinal jig module 220 may move closer to or away from the first longitudinal jig module 210.

One of the first longitudinal jig module 210 and the second longitudinal jig module 220 may face the second side case 52 (see FIG. 1). For example, the first longitudinal jig module 210 may face the second side case 52 (see FIG. 1).

The first longitudinal jig module 210 may include an opening. The opening of the first longitudinal jig module 210 may correspond to the terminal unit 60 (see FIG. 1). For example, the terminal unit 60 (see FIG. 1) may be positioned or accommodated in, or coupled to the opening of the first longitudinal jig module 210.

The battery cutting device 10 may include a width jig unit 300. The width jig unit 300 may include a first width jig module 310 and a second width jig module 320.

The first width jig module 310 and the second width jig module 320 may be arranged in a width direction of the battery cutting device 10. The width direction of the battery cutting device 10 may be the width direction (or transverse direction) of the secondary battery 5 (see FIG. 1).

The first width jig module 310 and the second width jig module 320 may face each other. The first width jig module 310 and the second width jig module 320 may be spaced apart from each other. Each of the first width jig module 310 and the second width jig module 320 may include a plate.

The first width jig module 310 and the second width jig module 320 may approach or move away from each other. For example, one of the first width jig module 310 and the second width jig module 320 may be fixed, and the other may move. For example, the first width jig module 310 may be fixed, and the second width jig module 320 may move closer to or away from the first width jig module 310.

Referring to FIGS. 1 to 3, the secondary battery 5 may be disposed on the jig units 100, 200, and 300.

For example, the secondary battery 5 may be disposed on the thickness jig unit 100. For example, the secondary battery 5 may be disposed between the first thickness jig module 110 and the second thickness jig module 120.

The first side case 51 of the secondary battery 5 may face the thickness jig unit 100. For example, the first side case 51 may face one of the first thickness jig module 110 and the second thickness jig module 120.

For example, the secondary battery 5 may be disposed on the longitudinal jig unit 200. For example, the secondary battery 5 may be disposed between the first longitudinal jig module 210 and the second longitudinal jig module 220.

The second side case 52 of the secondary battery 5 may face the longitudinal jig unit 200. For example, the second side case 52 may face one of the first longitudinal jig module 210 and the second longitudinal jig module 220.

For example, the secondary battery 5 may be disposed on the width jig unit 300. For example, the secondary battery 5 may be disposed between the first width jig module 310 and the second width jig module 320.

The third side case 53 of the secondary battery 5 may face the width jig unit 300. For example, the third side case 53 may face one of the first width jig module 310 and the second width jig module 320.

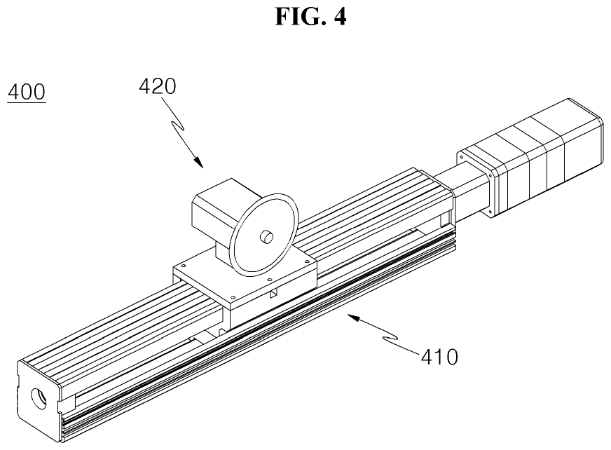

FIG. 4 illustrates a cutter unit 400 based on an embodiment of the disclosed technology.

Referring to FIG. 4, the cutter unit 400 may include a moving module 410. The moving module 410 may be coupled to the jig units 100, 200, and 300. The jig units 100, 200, and 300 may include or indicate at least one of the thickness jig unit 100, the longitudinal jig unit 200, or the width jig unit 300.

The cutter unit 400 may include a cutting module 420. The cutting module 420 may be coupled to the moving module 410. The cutting module 420 may move on the moving module 410. For example, the cutting module 420 may reciprocate in a longitudinal direction of the moving module 410.

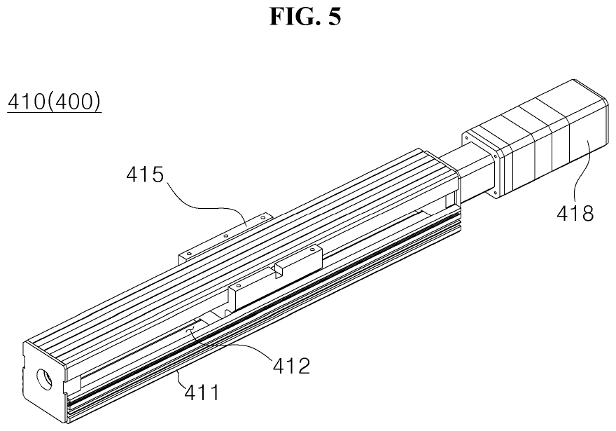

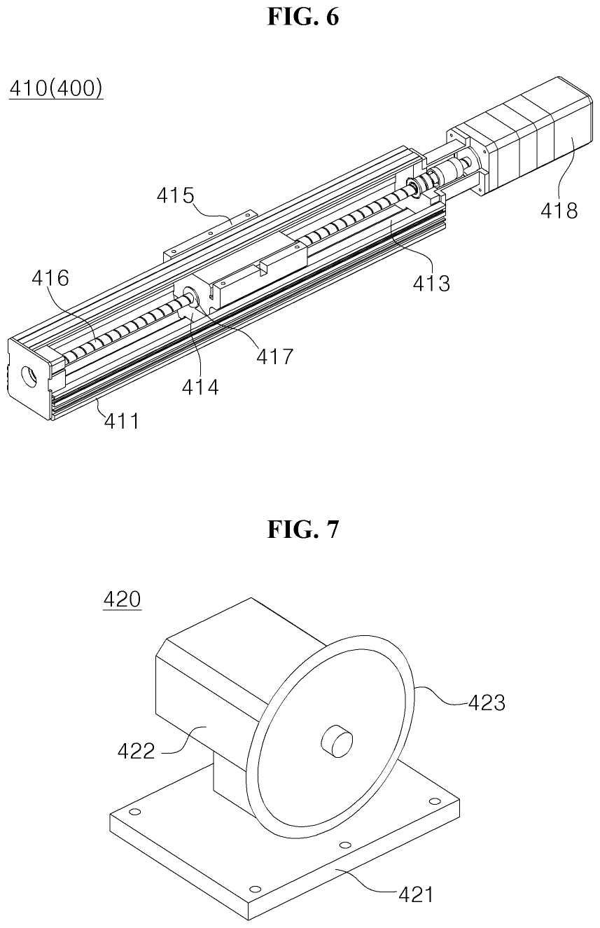

FIG. 5 illustrates the moving module 410 based on an embodiment of the disclosed technology. FIG. 6 illustrates that a part of the moving module 410 illustrated in FIG. 5 is cut.

Referring to FIGS. 5 and 6, the moving module 410 may include a frame 411. The frame 411 may form a skeleton of the moving module 410. A longitudinal direction of the frame 411 may be the longitudinal direction of the moving module 410. The frame 411 may be coupled to the jig units 100, 200, and 300. The frame 411 may form a space inside. Multiple components may be accommodated in the inner space formed in the frame 411.

The moving module 410 may include a window 412. The window 412 may be an opening formed in the frame 411. The window 412 may form a slit shape extending in the longitudinal direction of the moving module 410. The inside and outside of the frame 411 may be connected or communicate with each other through the window 412.

The moving module 410 may include a guide rail 413. The guide rail 413 may form a shape extending in the longitudinal direction of the moving module 410. The guide rail 413 may be accommodated in or coupled to the frame 411.

The moving module 410 may include a guide block 414. The guide block 414 may be accommodated in the frame 411. The guide block 414 may be coupled to the guide rail 413. For example, the guide block 414 may be movably or slidably coupled to the guide rail 413. For example, the guide block 414 may move along the guide rail 413 in the longitudinal direction of the moving module 410.

The moving module 410 may include a guide table 415. The guide table 415 may be mounted or coupled to the guide block 414. The guide table 415 may form a shape extending from the guide block 414. The guide table 415 and the guide block 414 may be formed as a unibody.

A portion of the guide table 415 may pass through the window 412. For example, the guide table 415 may form a shape that extends from the inside of the frame 411 and passes through the window 412.

The moving module 410 may include a moving rod 416. The moving rod 416 may be accommodated in or coupled to the frame 411. The moving rod 416 may form a shape extending in the longitudinal direction of the moving module 410. The moving rod 416 may be disposed parallel to the guide rail 413. For example, a thread may be formed on an outer surface of the moving rod 416.

The moving module 410 may include a rod coupler 417. The rod coupler 417 may be coupled, formed, or connected to at least one of the guide block 414 and the guide table 415.

The rod coupler 417 may form a hole. The rod coupler 417 may be coupled to the moving rod 416. For example, the rod coupler 417 may be movably coupled to the moving rod 416. For example, the moving rod 416 may penetrate the rod coupler 417.

The rod coupler 417 may form a surface contacting the moving rod 416. A thread may be formed on the surface of the rod coupler 417 contacting the moving rod 416. The thread formed on the rod coupler 417 may be coupled to the thread formed on the moving rod 416.

The moving module 410 may include a moving motor 418. The moving motor 418 may be connected, fixed, or coupled to the frame 411. Alternatively, the moving motor 418 may be accommodated in the frame 411. The moving motor 418 may be coupled to the moving rod 416. The moving motor 418 may provide a rotational force to the moving rod 416.

When the moving rod 416 rotates, the rod coupler 417 may convert a rotational movement of the moving rod 416 into a translational movement. For example, when the moving rod 416 rotates in a first rotation direction, the rod coupler 417 may move in a first linear direction. For example, when the moving rod 416 rotates in a second rotation direction, the rod coupler 417 may move in a second linear direction.

The first rotation direction and the second rotation direction may be opposite rotation directions to each other. The first rotation direction and the second rotation direction may be directions of rotation around a rotation axis of the moving rod 416. The rotation axis of the moving rod 416 may be parallel to the longitudinal direction of the moving module 410.

The first linear direction and the second linear direction may be linear directions opposite to each other. The first linear direction and the second linear direction may be parallel to the longitudinal direction of the moving module 410.

The guide block 414 may move on the guide rail 413 by receiving a force from the rod coupler 417. When the guide block 414 moves, the guide table 415 may move. When the guide table 415 moves, the cutting module 420 (see FIG. 4) coupled to the guide table 415 may move.

FIG. 7 illustrates the cutting module 420 based on an embodiment of the disclosed technology.

Referring to FIGS. 5 to 7, the cutting module 420 may include a cutting table 421. The cutting table 421 may be mounted or coupled to the moving module 410. For example, the cutting table 421 may be mounted, coupled, or fixed to the guide table 415. Therefore, when the guide table 415 moves, the cutting table 421 may move.

The cutting module 420 may include a cutting motor 422. The cutting motor 422 may be installed, connected, fixed, or coupled to the cutting table 421. The cutting motor 422 may rotate.

The cutting module 420 may include a cutting blade 423. The cutting blade 423 may be connected or coupled to the cutting motor 422. The cutting blade 423 may rotate by receiving a rotational force from the cutting motor 422.

The cutting blade 423 may be applied to the secondary battery case 50 (see FIG. 1). When the cutting blade 423 is applied to the secondary battery case 50 (see FIG. 1), the cutting blade 423 may cut the secondary battery case 50 (see FIG. 1).

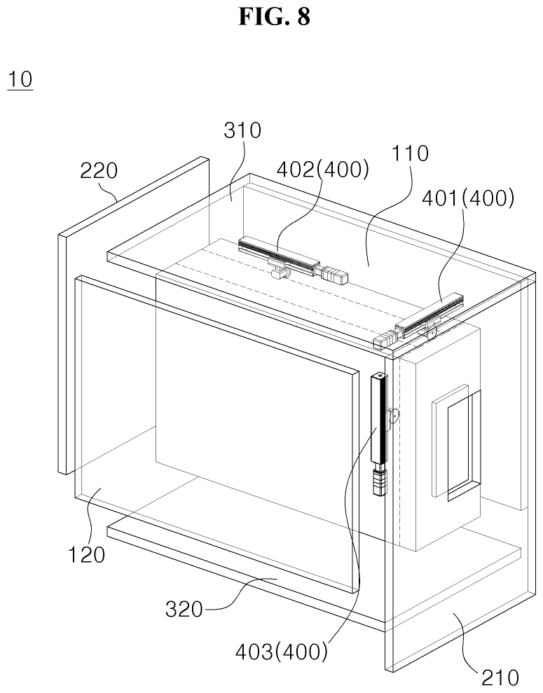

FIG. 8 schematically illustrates that the battery cutting device 10 based on an embodiment of the disclosed technology cuts the secondary battery 5.

For convenience of description, a portion of the second thickness jig module 120 may not be illustrated in FIG. 8. For example, a portion of the second thickness jig module 120 coupled to a width cutter unit 403 may not be illustrated in FIG. 8.

For convenience of description, FIG. 8 may illustrate that the first longitudinal jig module 210, the second thickness jig module 120, and the first width jig module 310 are transparent. For convenience of description, FIG. 8 may illustrate that the secondary battery 5 is disposed above the second width jig module 320 and is spaced apart from the second width jig module 320.

Referring to FIGS. 1 to 8, a plurality of cutter units 400 may be provided.

For example, the cutter unit 400 may include a thickness cutter unit 401. The thickness cutter unit 401 may be coupled, installed, or fixed to the width jig unit 300. For example, the thickness cutter unit 401 may be installed or fixed to the first width jig module 310. For example, the thickness cutter unit 401 may be installed or fixed to an inner surface of the first width jig module 310. The inner surface of the first width jig module 310 may face the second width jig module 320.

The longitudinal direction of the moving module 410 of the thickness cutter unit 401 may be parallel to the thickness direction of the battery cutting device 10. The cutting module 420 of the thickness cutter unit 401 may move in the thickness direction of the battery cutting device 10.

The cutting module 420 of the thickness cutter unit 401 may face the secondary battery 5. The cutting module 420 of the thickness cutter unit 401 may be spaced apart from the secondary battery 5. When the second width jig module 320 moves toward the first width jig module 310, the cutting blade 423 of the thickness cutter unit 401 may contact the secondary battery 5.

In a state in which the cutting blade 423 of the thickness cutter unit 401 is in contact with the secondary battery 5, the cutting blade 423 of the thickness cutter unit 401 may rotate. In a state in which the cutting blade 423 of the thickness cutter unit 401 rotates, the cutting module 420 of the thickness cutter unit 401 may move in the thickness direction. Through the above process, the secondary battery 5 may be cut in the thickness direction.

For example, the cutter unit 400 may include a longitudinal cutter unit 402. The longitudinal cutter unit 402 may be coupled, installed, or fixed to the width jig unit 300. For example, the longitudinal cutter unit 402 may be installed or fixed to the first width jig module 310. For example, the longitudinal cutter unit 402 may be installed or fixed to an inner surface of the first width jig module 310.

The longitudinal direction of the moving module 410 of the longitudinal cutter unit 402 may be parallel to the longitudinal direction of the battery cutting device 10. The cutting module 420 of the longitudinal cutter unit 402 may move in the longitudinal direction of the battery cutting device 10.

The cutting module 420 of the longitudinal cutter unit 402 may face the secondary battery 5. The cutting module 420 of the longitudinal cutter unit 402 may be spaced apart from the secondary battery 5. When the second width jig module 320 moves toward the first width jig module 310, the cutting blade 423 of the longitudinal cutter unit 402 may contact the secondary battery 5.

In a state in which the cutting blade 423 of the longitudinal cutter unit 402 is in contact with the secondary battery 5, the cutting blade 423 of the longitudinal cutter unit 402 may rotate. In a state in which the cutting blade 423 of the longitudinal cutter unit 402 rotates, the cutting module 420 of the longitudinal cutter unit 402 may move in the longitudinal direction. Through the above process, the secondary battery 5 may be cut in the longitudinal direction.

For example, the cutter unit 400 may include a width cutter unit 403. The width cutter unit 403 may be coupled, installed, or fixed to the thickness jig unit 100. For example, the width cutter unit 403 may be installed or fixed to the first thickness jig module 110.

For example, the width cutter unit 403 may be installed or fixed to an inner surface of the first thickness jig module 110. For another example, the width cutter unit 403 may be installed or fixed to an inner surface of the second thickness jig module 120. The inner surface of the first thickness jig module 110 may face the inner surface of the second thickness jig module 120.

The longitudinal direction of the moving module 410 of the width cutter unit 403 may be parallel to the width direction of the battery cutting device 10. The cutting module 420 of the width cutter unit 403 may move in the width direction of the battery cutting device 10.

The cutting module 420 of the width cutter unit 403 may face the secondary battery 5. The cutting module 420 of the width cutter unit 403 may be spaced apart from the secondary battery 5. When the second thickness jig module 120 moves toward the first thickness jig module 110, the cutting blade 423 of the width cutter unit 403 may contact the secondary battery 5.

In a state in which the cutting blade 423 of the width cutter unit 403 is in contact with the secondary battery 5, the cutting blade 423 of the width cutter unit 403 may rotate. In a state in which the cutting blade 423 of the width cutter unit 403 rotates, the cutting module 420 of the width cutter unit 403 may move in the width direction. Through the above process, the secondary battery 5 may be cut in the width direction.

The first width jig module 310 may be disposed on the secondary battery 5. The second width jig module 320 may be disposed below the secondary battery 5. The first thickness jig module 110 may be disposed behind the secondary battery 5. The second thickness jig module 120 may be disposed in front of the secondary battery 5. The first longitudinal jig module 210 may be disposed on the right side of the secondary battery 5. The second longitudinal jig module 220 may be disposed on the left side of the secondary battery 5.

Only specific examples of implementations of certain embodiments are described. Variations, improvements and enhancements of the disclosed embodiments and other embodiments may be made based on the disclosure of this patent document.

What is claimed is:

1. A battery cutting device comprising:
a jig unit including a longitudinal jig unit, a thickness jig unit, and a width jig unit; and
a cutter unit coupled to the jig unit,
wherein the longitudinal jig unit includes a first longitudinal jig module and a second longitudinal jig module that are arranged in a longitudinal direction and approach or move away from each other,
wherein the thickness jig unit includes a first thickness jig module and a second thickness jig module that are arranged in a thickness direction and approach or move away from each other,
wherein the width jig unit includes a first width jig module and a second width jig module that are arranged in a width direction and approach or move away from each other,
wherein the cutter unit includes:
a moving module fixed to the jig unit; and
a cutting module coupled to the moving module to be movable in one direction, the cutting module including a cutting blade.

2. The battery cutting device of claim 1, wherein the cutter unit further includes a thickness cutter unit coupled to the width jig unit, and
wherein the cutting module of the thickness cutter unit is coupled to the moving module of the thickness cutter unit to be movable in the thickness direction.

3. The battery cutting device of claim 2, wherein the thickness cutter unit is coupled to an inner surface of the first width jig module, and
wherein the inner surface of the first width jig module faces the second width jig module.

4. The battery cutting device of claim 3, wherein the cutter unit further includes a longitudinal cutter unit coupled to the width jig unit, and
wherein the cutting module of the longitudinal cutter unit is coupled to the moving module of the longitudinal cutter unit to be movable in the longitudinal direction.

5. The battery cutting device of claim 4, wherein the longitudinal cutter unit is coupled to the inner surface of the first width jig module, and
wherein the second width jig module approaches or moves away from the first width jig module.

6. The battery cutting device of claim 5, wherein the first width jig module is positioned above the second width jig module.

7. The battery cutting device of claim 4, wherein the cutter unit further includes a width cutter unit coupled to the thickness jig unit, and
wherein the cutting module of the width cutter unit is coupled to the moving module of the width cutter unit to be movable in the width direction.

8. The battery cutting device of claim 7, wherein the width cutter unit is coupled to an inner surface of the first thickness jig module, and
wherein the inner surface of the first thickness jig module faces the second thickness jig module.

9. The battery cutting device of claim 8, wherein the second thickness jig module approaches or moves away from the first thickness jig module.

10. The battery cutting device of claim 7, wherein a movement path of the cutting module of the width cutter unit meets a movement path of the cutting module of the thickness cutter unit.

11. The battery cutting device of claim 7, wherein a movement path of the cutting module of the thickness cutter unit meets a movement path of the cutting module of the longitudinal cutter unit.

12. The battery cutting device of claim 7, wherein the first thickness jig module is positioned behind the second thickness jig module, and
wherein the first width jig module is positioned above the second width jig module.

13. The battery cutting device of claim 7, wherein the first longitudinal jig module forms an opening.

14. The battery cutting device of claim 1, wherein the moving module includes:
a frame fixed to the jig unit;
a guide rail installed on the frame and forming a shape extending in the one direction;
a guide block installed on the frame and coupled to the guide rail to be movable in the one direction; and
a guide table coupled to the guide block and coupled to the cutting module.

15. The battery cutting device of claim 14, wherein the moving module further includes:
a moving rod installed on the frame and forming a shape extending in the one direction; and
a rod coupler coupled to at least one of the guide block or the guide table and movably coupled to the moving rod,
wherein, based on the moving rod rotating, the cutting module moves in the one direction.
